(19) United States
(12) Patent Application Publication
(10) Pub. No.: US 2008/0147531 A1
(43) Pub. Date: Jun. 19, 2008

(54) METHODS AND SYSTEMS FOR DOCUMENTING AND PERFECTING REAL ESTATE SECURITY INTERESTS BY SEPARATING MORTGAGE CONTENT INTO RECORDABLE AND NON-RECORDABLE SECTIONS

(76) Inventor: Donald Edward Holly, Becker, MN (US)

Correspondence Address: MICHAEL BEST & FRIEDRICH LLP, 100 E WISCONSIN AVENUE, Suite 3300, MILWAUKEE, WI, 53202, US

(21) Appl. No.: 11/956,491

(22) Filed: Dec. 14, 2007

Related U.S. Application Data
(60) Provisional application No. 60/875,079, filed on Dec. 15, 2006.

(51) Int. Cl. G06Q 40/00; G06Q 99/00

(52) U.S. Cl. 705/35; 705/1

(57) ABSTRACT

Computer implemented systems and methods for creating a multiple-part mortgage document. The multiple-part mortgage document includes a recordable legal instrument and a non-recordable legal instrument. The systems and methods are configured to select content to be included and determine whether the content is placed in the recordable portion or the non-recordable portion.

### RELATED APPLICATION

This patent application claims the benefit of U.S. provisional patent application No. 60/875,079 filed on Dec. 15, 2006.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

A consensual real estate lien is created by a written document signed by those persons or entities that have interests in the real estate. The document is called either a mortgage or a deed of trust. Mortgages are the preferred documents for real estate liens in some states, and deeds of trust are the preferred document for real estate liens in other states. The document chosen by a state as the preferred document may depend on the historical practice of the state and/or the legal advantages that one document type has over the other. A deed of trust is distinguished from a mortgage by the participation of a “trustee” who takes legal title in the real estate but must convey the legal title back if the secured debt is paid or the interest is relinquished. Otherwise, a mortgage and a deed of trust generally accomplish the same purposes by the same methods, and, as used with this disclosure, the term “mortgage” refers to both types of documents.

Historically, mortgage documents have been printed on paper. For the consensual lien created by the paper mortgage document to be perfected against other creditors, the paper mortgage document has to be recorded in the jurisdiction (e.g., the county, the parish, or other municipal entity) where the real estate associated with the lien is located. Today, mortgages can be signed “electronically” and, in some jurisdictions, can be recorded electronically.

The Federal National Mortgage Association (“FNMA”) and the Federal Home Loan Mortgage Corporation (“FHLMC”) are the leading secondary market buyers of mortgage loans in the United States. Each of these organizations has developed its own mortgage instruments. The organizations have also collaborated to create real estate mortgage documents. If a lender wants to sell a mortgage secured loan to the FNMA or the FHLMC, the lender needs to use an FNMA/FHLMC instrument (e.g., mortgage document) and needs to record the transaction with the applicable registry or registrar in order to perfect the transaction.

Over the years, recordable mortgage instruments have increased in length to include (as best known to the inventor) as many as 16 pages. Generally, a large part of the content included in a recordable mortgage instrument is boilerplate language of lenders (“mortgagees”). However, most of the boilerplate language does not need to be included in public records associated with the mortgage in order to perfect a lender's interest in the collateral. In addition, even if the boilerplate language is recorded, the recorded language does not enhance the lender's secured position. For example, when lawyers or title insurance companies examine a title to a property, they examine an abstract of the recorded documents, and abstractors, who create abstracts, only include those elements within the abstract that the title examiner cares about. Those elements can vary from state to state depending on the real estate law of each state but can include the mortgagees name(s), the marital status of the mortgagees (e.g., if relevant in the state where the real estate is located), the lender's name(s), the trustee's name (e.g., in the case of a deed of trust), the legal description of the property, the amount of the debt secured, the maturity date of the debt, and the existence of a “power of sale.”

Thus, a multiple page mortgage document is reduced to just a few lines of text in an abstract. However, many mortgagors are not prepared to forego all the boilerplate language (e.g., promises and provisions) within the standard recorded documents simply for the sake of shortening the document that is recorded.

### SUMMARY

Besides being unnecessary, a lengthy recordable mortgage instrument can have significant drawbacks. One problem relates to handling and filing fees. A substantially large percentage of recording districts charge for recording mortgage instruments on a per-page basis. For example, filing fees for recording an instrument can be approximately $4.00 a page or more. Therefore, the more pages included in a recordable mortgage instrument, the larger the filing fee.

A lengthy mortgage instrument can have additional drawbacks. For example, at closing, all mortgagors typically initial each page of the mortgage instrument. If the mortgage instrument is considerably long, the mortgagor may not actually read every page of the instrument before initialing each page. In addition, a number of parties may be associated with a mortgage and each party may be required to initial every page of the mortgage instrument and may be required to initial a copy of the mortgage instrument for each party associated with the mortgage. For example, typically a closer prints out four copies of a mortgage instrument and each party associated with the mortgage initials each page of each of the copies. If the mortgage document is 16 pages long, each party would need to initial 60 pages, and, the more pages each party has to initial, the greater the time required at the closing of the mortgage and the greater the opportunity for errors.

Shortened versions of recordable mortgage instruments have been proposed in the past. For example, recordable mortgage instruments have been offered that include four-part forms printed on the front and the back of two pages. The recording districts, however, often require mortgage instruments to be printed on only one side of a piece of paper since they microfilm the instruments. The previously provided shortened forms also did not and could not contain all the covenants that lenders had become accustomed to seeing and so they were not accepted or preferred by lenders. In addition, the shortened forms were often printed on oversized pieces of paper (e.g., 14 inches long), which often caused difficulties with printing and filing the forms.

Numerous states have sanctioned, by statute, the “master mortgage” concept. In the master mortgage concept a blank long mortgage form is recorded that includes all the boilerplate material associated with a mortgage. Then, a lender records a short mortgage form that includes only the transaction-specific information and references the long mortgage form. This concept suffers from the fact that the long mortgage form needs to recorded first, both the long and short mortgage forms are signed at closing, the long mortgage form needs to be updated and re-recorded if it gets changed (e.g., in every local registry where the long mortgage form is to be used), and the concept fails to acknowledge that much of the content in the long mortgage form does not need to be recorded.

Embodiments of the invention provide methods and systems for documenting and perfecting a transaction (e.g., a real estate security interest transaction) by separating transaction content into a recordable section or instrument (to be recorded, for example, at the county or the district level) and a non-recordable section or instrument, which together form a single, binding agreement. The recordable instrument includes what is necessary and sufficient to put a secured party (e.g., a lender) in its rightful secured position. The non-recordable instrument includes the remaining legal provisions such as boilerplate language of the mortgage instrument and any additional language and information not required to be recorded.

The recordable instrument can be delivered to an applicant in a paper format and can include two one-sided pages of an oversized size (e.g., 13 inches long, 14 inches long, etc.) or can include two one-sided pages of a standard size (e.g., 8.5 inches by 11 inches). In some embodiments, the recordable instrument also includes a third page if certain conditions prevail in a particular transaction. For example, if a property associated with a mortgage is a condominium or is part of a Planned Unit Development or if the loan provides for negative amortization, the recordable instrument may include a third page. In some embodiments, the third (e.g., middle) page deals with options that occur infrequently, and, therefore, the third page is discarded in most cases.

The recordable instrument can also be delivered to a customer (e.g., the lender or its agents) in an electronic (or, more broadly, non-paper) format. If the recordable instrument is delivered in an electronic format, the recordable instrument can include (e.g., when printed in hardcopy form or when viewed on a display) two one-sided pages of an oversized size or two one-side pages of a standard size (e.g., 8.5 inches by 11 includes).

In an electronic format, the recordable instrument can include a “static” document and/or a “dynamic” document. A static document can include a copy of the recordable instrument in an electronic format (e.g., a generic word processor format, a Portable Document Format (“PDF”), etc.). A dynamic document can include logic that eliminates unused or unneeded sections from an instrument before generating a final version of the instrument (e.g., printing a hardcopy of the instrument). For example, if there is no negative amortization associated with a mortgage, logic included in a dynamic document can eliminate the section of the recordable instrument associated with negative amortization before generating a final version of the instrument. Similarly, logic included in a dynamic document can eliminate blank space included in an instrument before generating a final version of the instrument. For example, if a legal description of a mortgage only takes up two lines of space of an available four lines of space, logic included in a dynamic document can eliminate the extra lines of space from the final version of an instrument. In some embodiments, a mortgage instrument delivered in an electronic format and including a dynamic document is shorter than a similar mortgage instrument provided in a paper format since logic included in the dynamic document can eliminate unused or unneeded text, space, etc. from the instrument.

The non-recordable instrument can also be delivered to one or more parties associated with a mortgage and can be delivered to the parties in a number of formats (e.g., a paper format or an electronic format, such as an email, an electronic form accessible via a network, etc.) at a number of different times during the mortgage application process or and/or during the closing process. As described above with respect to the recordable instrument, if the non-recordable instrument is delivered to a party in an electronic format, the non-recordable instrument can include a static document and/or a dynamic document.

In some embodiments, the non-recordable instrument includes a collection of the uniform covenants of the FNMA/FHLMC documents and all the non-uniform covenants from all possible states, counties, districts, or locations (e.g., the 50 states of the U.S. and the District of Columbia). For example, a lender who operates nationwide can generate a non-recordable instrument that includes all of the possible uniform and non-uniform covenants and can distribute the non-recordable instrument to a party before a loan actually closes. In other embodiments, the non-recordable instrument can be modified such that it only includes the uniform covenants and the non-uniform covenants for the state, county, or district where the property associated with the mortgage is located. In still other embodiments, the non-recordable instrument can be modified to include only the uniform covenants and the non-uniform covenants for all states, counties, and districts that a particular lender or financial institution services.

In some embodiments, the non-recordable instrument can include text or language that explains the purpose of the instrument and how it supplements what is recorded via the recordable instrument. The recordable instrument can also include an acknowledgment of the signer of the agreement to and acceptance of the promises and provisions included in the non-recordable instrument.

The non-recordable instrument and/or the recordable instrument can be manually generated or can be automatically generated. If automatically generated, the generated instruments can be provided to a user for manual review before final versions of the instruments are generated.

Another embodiment of the invention includes a method of creating a multiple-part mortgage document. The method includes determining applicable content to be included in the multiple-part mortgage document for a particular mortgage transaction; and determining a recordable portion of the applicable content, where the recordable portion of the applicable content includes legal provisions that affect the rights, obligations, or both of the parties to the mortgage transaction. The method also includes creating a recordable instrument including the recordable portion of the applicable content, where the recordable instrument is configured to secure a security interest in property associated with the mortgage transaction; determining a non-recordable portion of the applicable content; creating a non-recordable instrument including the non-recordable portion of the applicable content; and placing a reference in the recordable instrument, the non-recordable instrument, or both indicating that the recordable instrument and the non-recordable instrument are intended, together, to form a binding agreement.

### BRIEF DESCRIPTION OF THE DRAWINGS

FIG. 1 illustrates a method of documenting and perfecting a transaction according to one embodiment of the invention.

FIG. 2 illustrates a method of generating a recordable instrument and a non-recordable instrument according to one embodiment of the invention.

FIG. 3 illustrates a method of delivering an instrument to an individual according to one embodiment of the invention.

FIGS. 4A and 4B illustrate a system for documenting and perfecting a transaction according to one embodiment of the invention.

FIGS. 5A through 5C illustrate a blank sample recordable instrument according to an embodiment of the invention.

FIGS. 6A & 6B illustrate the sample recordable instrument illustrated in FIGS. 5A through 5C with fictitious transaction-specific information.

FIGS. 7A through 7C illustrate a blank sample recordable instrument according to an embodiment of the invention.

FIGS. 8A & 8B illustrate the sample recordable instrument illustrated in FIGS. 7A through 7C with fictitious transaction-specific information.

FIGS. 9A through 9L illustrate a sample non-recordable instrument associated with a single jurisdiction according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. It should be noted that a plurality of hardware and software based devices, as well as a plurality of different structural components, may be utilized to implement embodiments of the invention. Furthermore, and as described in subsequent paragraphs, the specific configurations illustrated in the drawings are intended to exemplify embodiments of the invention, and other alternative configurations are possible.

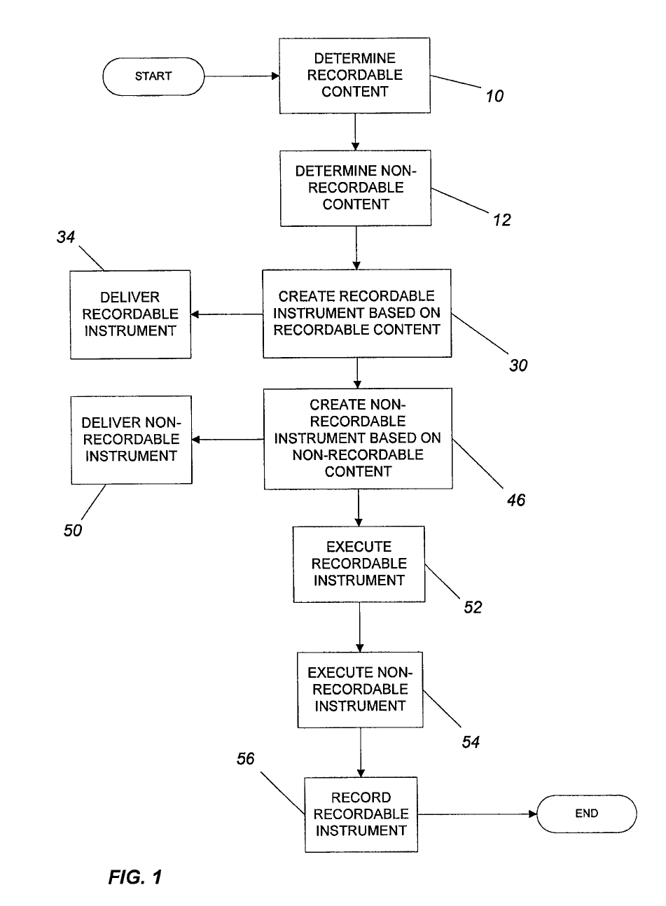

FIG. 1 illustrates a method of administering a transaction (e.g., a mortgage) according to one embodiment of the invention. Although mortgage transactions are the focus of the embodiments described, other embodiments of the invention can be applied to other documents and security instruments where it is unnecessary to record all the provisions in an agreement in order to perfect an interest in something of value.

As shown in FIG. 1, the first steps of the method include determining recordable information or content (step 10) and determining non-recordable content included in a document (e.g., standard mortgage content) (step 12).

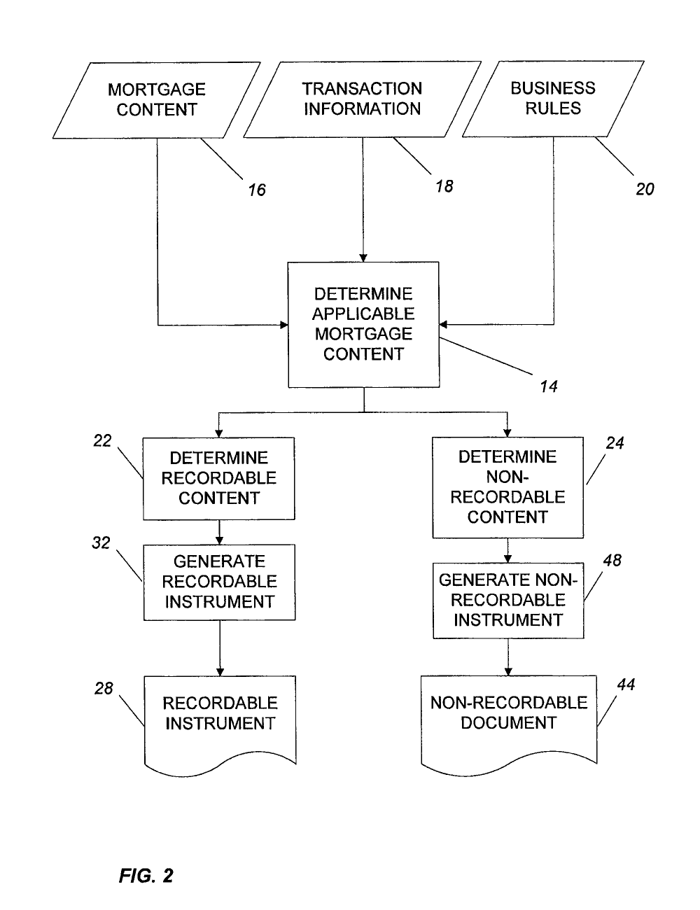

FIG. 2 illustrates a method of determining recordable and non-recordable mortgage content according to one embodiment of the invention. As shown in FIG. 2, as a first step to determining recordable and non-recordable content, applicable mortgage content can be determined for a transaction (step 14). The applicable content can be determined based on standard content 16. For example, as noted above, the recordable and non-recordable sections can be determined from a typical mortgage instrument, such as a FNMA/FHLMC document.

In some embodiments, applicable content for a transaction can default to include all standard content that may or may not be applicable to a typical transaction. In other embodiments, applicable content for a transaction can be determined based on details of the transaction. For example, as shown in FIG. 2, transaction information 18 can optionally be used to determine specific content that is applicable to a particular transaction. For example, if a transaction involves a property located in a specific state, district, or location, the applicable content can include specific language, provisions, etc. that relates to the state, district, or location where the property is located and, in some embodiments, can exclude the language, provisions, etc. that does not relate to the state, district, or location where the property is located.

As shown in FIG. 2, logic, such as one or more business rules 20, can specify content that is applicable to a particular transaction. For example, the business rules 20 can include rules, lookup tables, hash functions, etc. that specify content that is applicable to particular transactions. In some embodiments, a business rule 20 may specify that all standard, available, or possible content is, by default, applicable to each transaction. A business rule 20 may also specify that specific content is applicable to transactions associated with a particular lender or financial institution; transactions associated with a particular state, district, or locations; transactions associated with particular conditions (e.g., transactions involving condominiums); etc.

After applicable content is determined, recordable and non-recordable content can be determined based on the applicable content (see FIG. 2, steps 22 and 24). In particular, the non-recordable content can include boilerplate language from FNMA/FHLMC documents that does not enhance the lender's security and, therefore, does not need to be included in the recordable instrument and can be put into another deliverable format. Similarly, the recordable content can include content that is necessary to perfect the mortgage (or other interest) against subsequent purchasers and lenders. In some embodiments, current laws or regulations associated one or more registers or registrars can be referenced in order to determine what is required to be recorded for a particular transaction and what is not required to be recorded for a particular transaction. The business rules 20 can specify logic for determining recordable and/or non-recordable content.

It should be understood that in addition to or in place of the logic and the business rules 20, manual logic or judgment can be used to determine applicable content that satisfies the legal and market considerations and to determine what is necessary and advisable for a valid and optimally effective recordable instrument. For example, in order to assemble a recordable document, an individual can manually determine (e.g., by research) the real estate law of the state where the mortgage is be used. The individual can then collect and include all the provisions and transaction-specific information within the recordable document that are necessary to get the lender associated with the mortgage the highest possible priority over other creditors, purchases, and the trustee in bankruptcy, if the borrowers were to file for bankruptcy. The individual assembling the recordable document can also strive to give the lender all of the foreclosure and recovery options available so as to get the security property by the simplest, fastest, and cheapest techniques available. For example, most states permit foreclosure by a non-judicial procedure involving a public auction after notice, but most states require that the mortgage include language that permits such a foreclosure procedure.

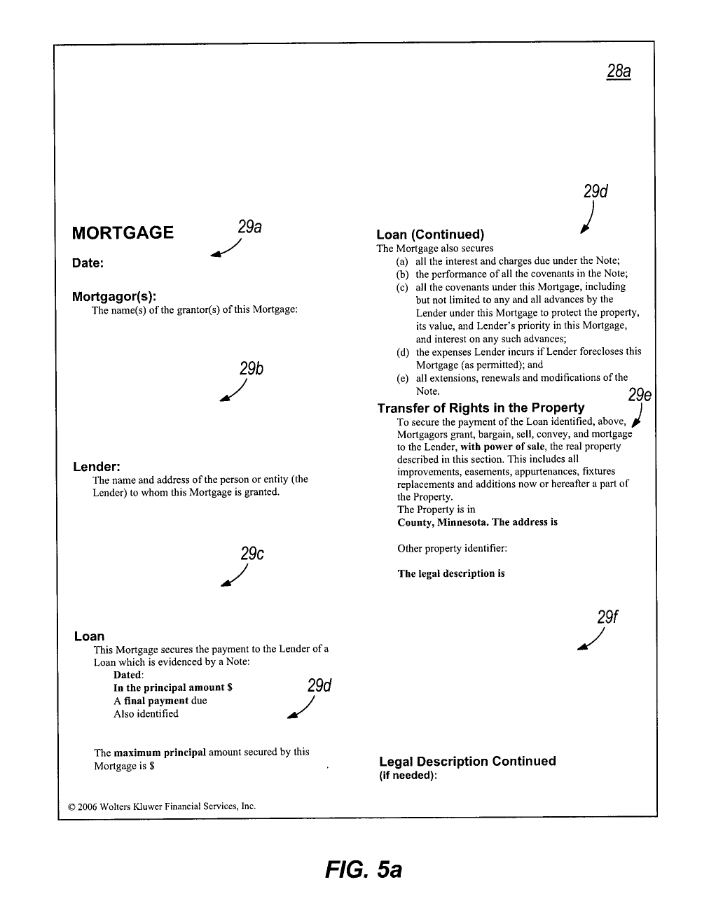

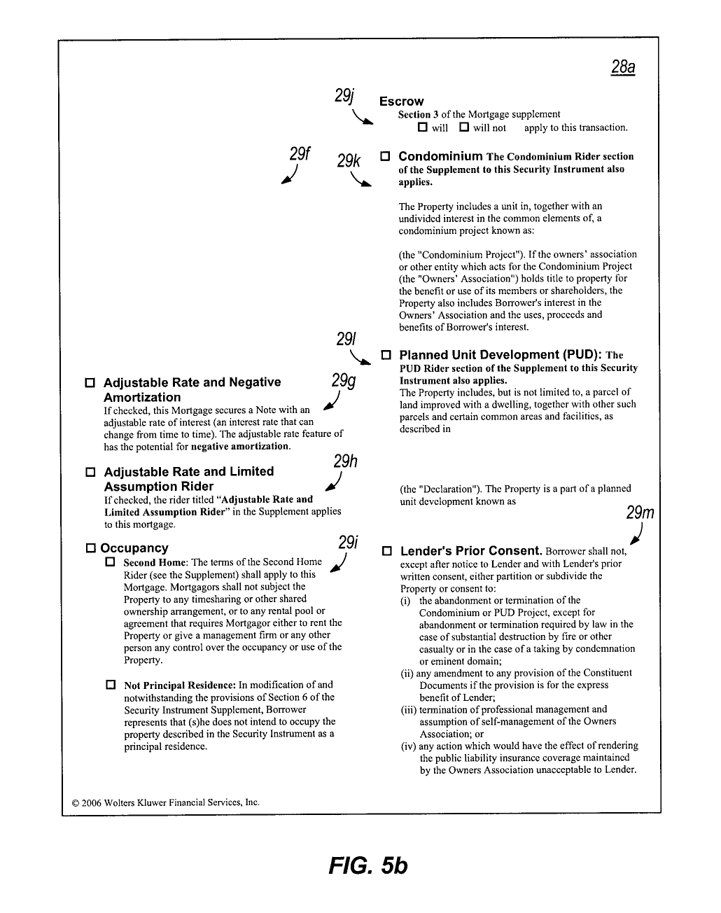

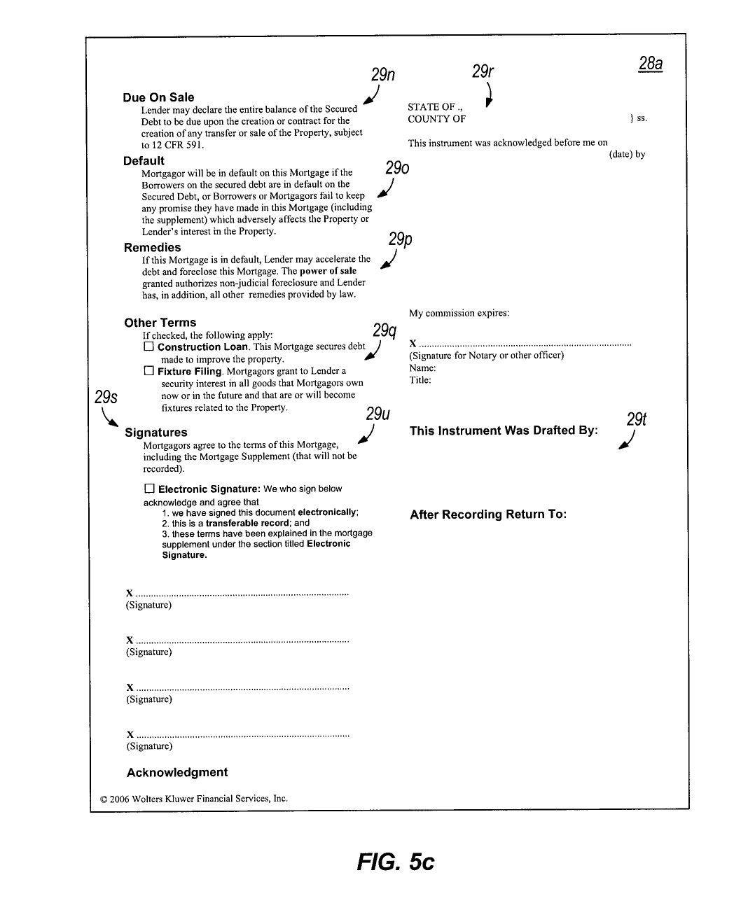

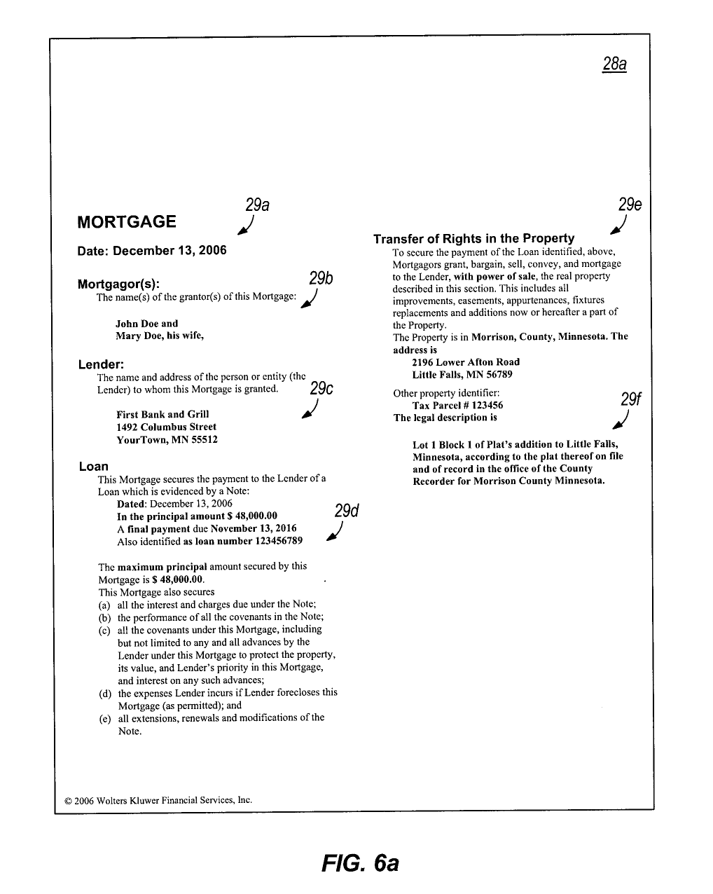

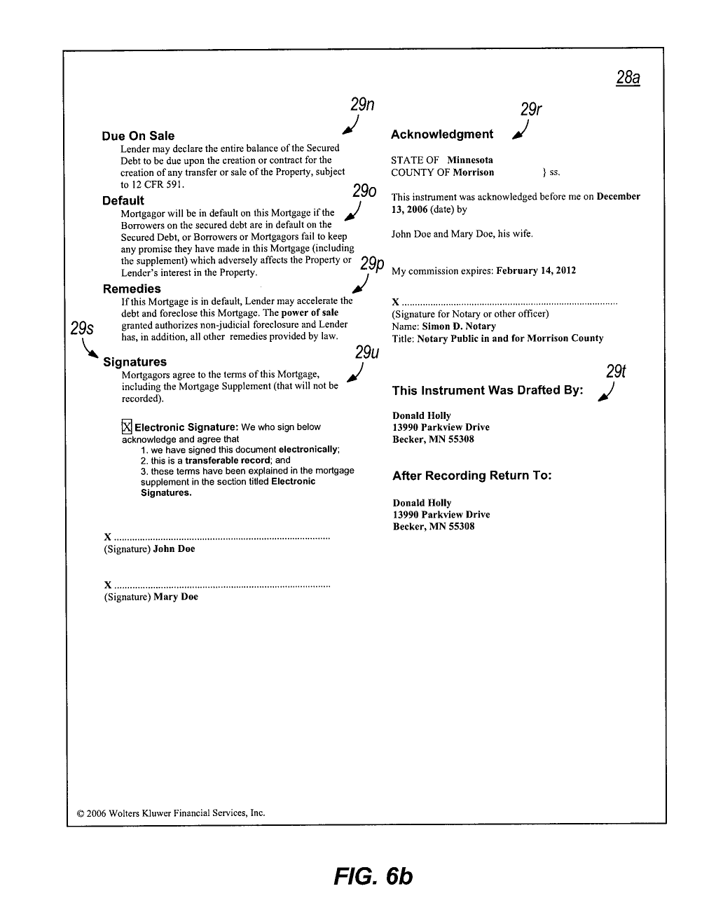

As shown in FIGS. 1 and 2, after the appropriate recordable and non-recordable content has been identified, a recordable instrument 28 can be generated based on the identified recordable content (steps 30 and 32, respectively). FIGS. 5A-5C illustrate a blank sample recordable instrument 28a according to an embodiment of the invention. The recordable instrument 28a is a sample recordable mortgage instrument, and, in particular, is a sample recordable mortgage instrument for the state of Minnesota. FIGS. 6A & 6B illustrate the recordable instrument 28a with fictitious transaction-specification information.

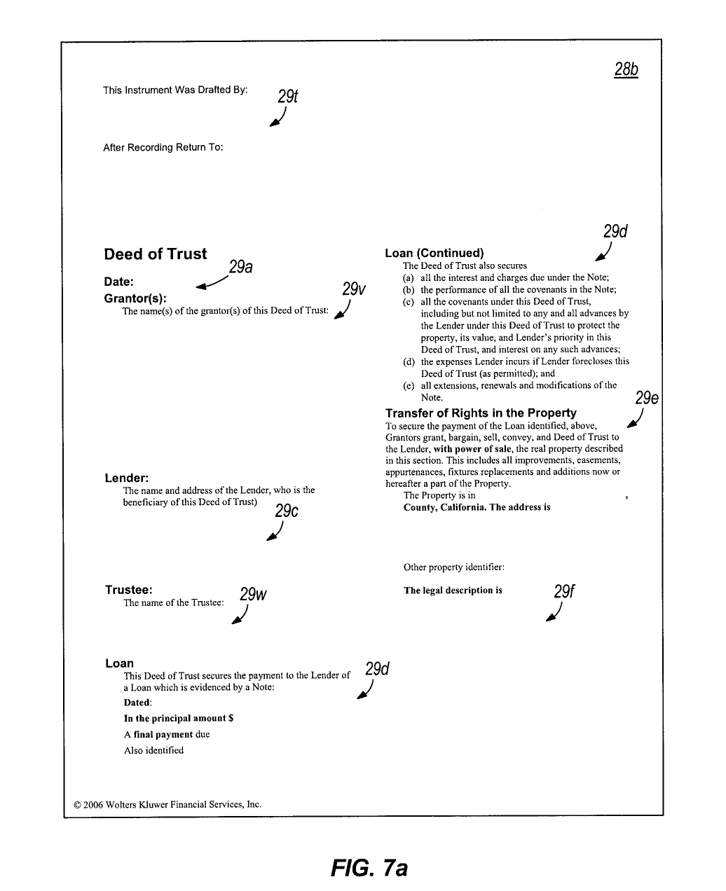

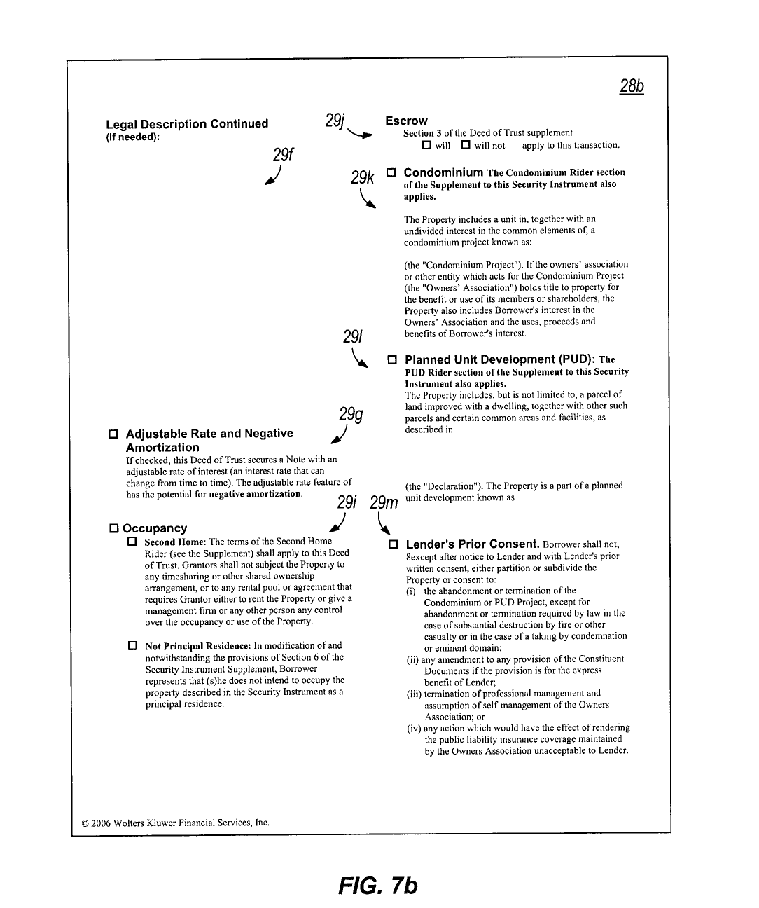

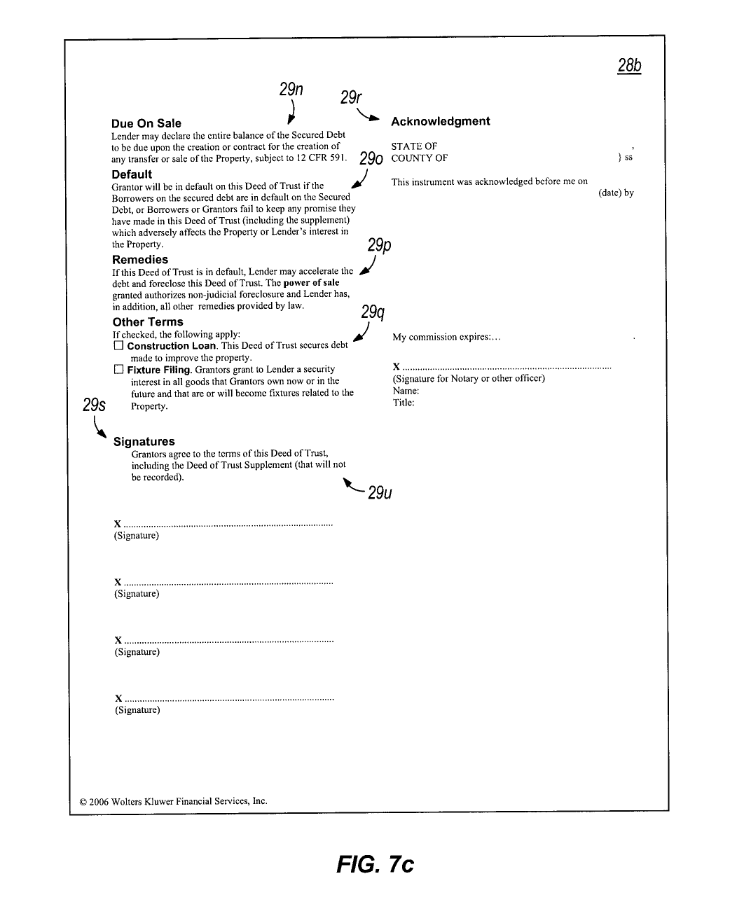

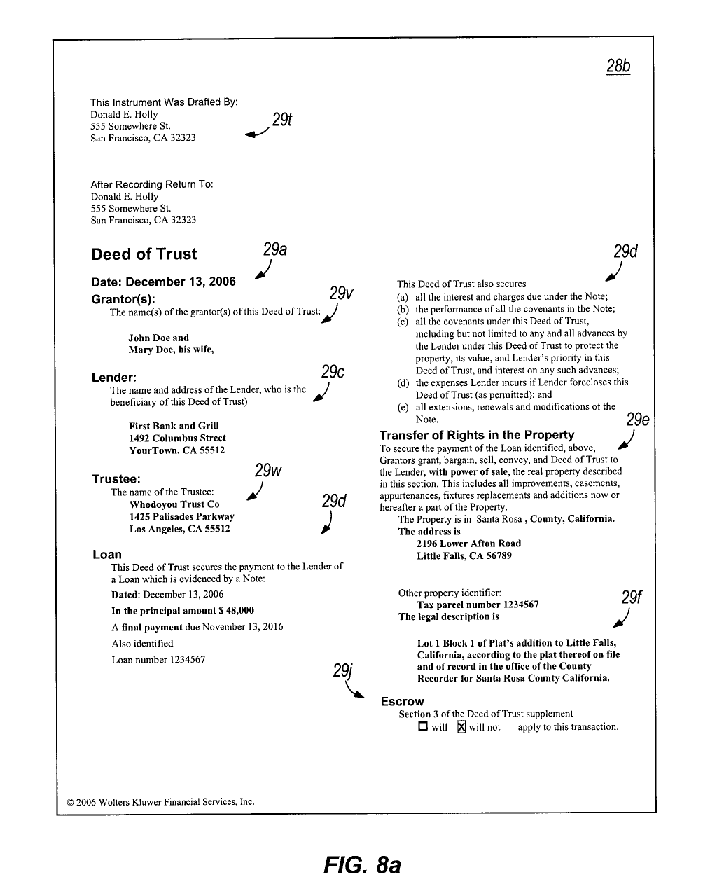

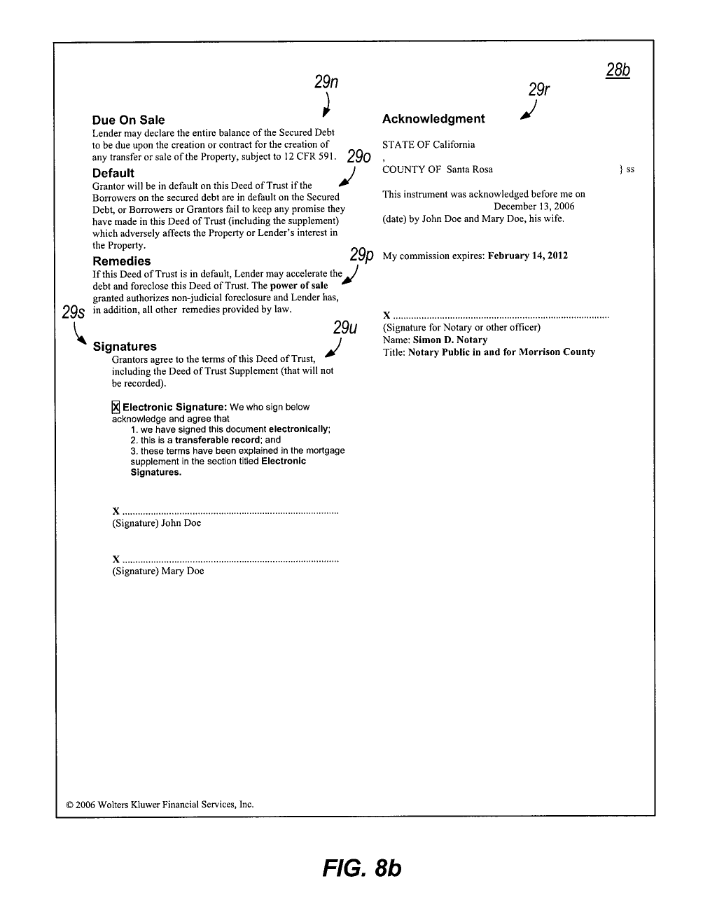

FIGS. 7A-7C illustrate a sample recordable instrument 28b according to an embodiment of the invention. The recordable instrument 28b is a sample recordable deed of trust instrument, and, in particular, is a sample recordable deed of trust instrument for the state of California. FIGS. 8A & 8B illustrate the recordable instrument 28b with fictitious transaction-specification information.

As shown in FIGS. 5A-5C, the recordable mortgage instrument 28a can include a date section 29a, a mortgagor(s) section 29b, a lender section 29c, a loan section 29d, a transfer of rights of property section 29e (including a legal description section 29f), an adjustable rate and negative amortization section 29g, an adjustable rate and limited assumption rider section 29h, an occupancy section 29i, an escrow section 29j, a condominium section 29k, a planned unit development section 29l, a lender's prior consent section 29m, a due on sale section 29n, a default section 29o, a remedies section 29p, an other terms section 29q, an acknowledgement section 29r, a signatures section 29s, and an instrument information section 29t. The instrument information section 29t can specify an entity that drafted the recordable mortgage instrument 28a and instructions regarding where to return the recordable mortgage instrument 28a after it is recorded. As shown in FIG. 5C, the signatures section 29s includes language 29u that specifies the signers of the recordable mortgage instrument 28a (i.e., the mortgagors) agree to and accept the promises and provisions included in the recordable mortgage instrument 28a and an associated non-recordable instrument (e.g., Mortgage Supplement). The signature section 29s also allows the signers of the recordable mortgage instrument 28a to sign the instrument electronically.

The deed of trust recordable instrument 28b illustrated in FIGS. 7A-7C can include similar sections as the recordable mortgage instrument 28a. For example, the deed of trust recordable instrument 28b illustrated in FIGS. 7A-7C includes the date section 29a, the lender section 29c, the loan section 29d, the transfer of rights of property section 29e including the legal description section 29f, the adjustable rate and negative amortization section 29g, the adjustable rate and limited assumption rider section 29h, the occupancy section 29i, an escrow section 29j, the condominium section 29k, the planned unit development section 29l, the lender's prior consent section 29m, the due on sale section 29n, the default section 29o, the remedies section 29p, the other terms section 29q, the acknowledgement section 29r, the signatures section 29s including the language 29u referencing the associated non-recordable deed of trust instrument, and the instrument information section 29t. The recordable deed of trust instrument 28b also includes a grantors section 29v and a trustee section 29w.

As noted above, the middle pages of the recordable mortgage instrument 28a and the recordable deed of trust instrument 28b can be optional. For example, the blank instruments 28a and 28b included in FIGS. 5A-5C and 7A-7C include three pages. When the instruments 28a and 28b are filled in with transaction-specific information, however, the completed instruments 28a and 28b, as shown in FIGS. 6A-6B and 8A-8B, may include only 2 pages since the middle pages can be eliminated. The middle pages are eliminated based on the occurrence of one or more situations. For example, if a mortgage transaction or a deed of trust transaction includes a substantially short legal description and does not include an adjustable rate and negative amortization, an adjustable rate and limited assumption rider, occupancy conditions, an escrow, a condominium rider, a planned unit development rider, or a lender's prior consent, the middle pages of the sample recordable mortgage instrument 28a and the sample recordable deed of trust instrument 28b may be able to be eliminated.

In some embodiments, the middle page (e.g., unneeded sections) can be manually eliminated from a recordable instrument 28. In other embodiments, the middle page (e.g., unneeded sections) can be automatically eliminated from a recordable instrument 28. For example, as described above, a recordable instrument 28 can include a dynamic document that includes logic that eliminates unused or unneeded sections from an instrument before generating a final version of the instrument (e.g., printing a hardcopy of the instrument).

As shown in FIGS. 5A-8B, the recordable instrument 28 includes binding and material legal provisions that set forth rights and obligations of the parties. The recordable instrument is one part of a two-part mortgage. The second part of the two-part mortgage is the non-recordable instrument. Binding legal provisions in the recordable instrument 28 can include, for example, loan sections 28d and 29d, which recite the maximum principal amount secured by the loan and the items secured by the transaction. Similarly, the transfer of rights in the property sections 28e and 29e state what is being conveyed in the transaction (e.g., the legal description of the property associated with the transaction). It should be understood that the recordable instrument is considered a part of the mortgage and, when executed, becomes part of a single binding agreement. The recordable instrument 28 is not merely a cover sheet or recordation sheet that provides brief details of a transaction (e.g., names and addresses of parties involved in the transaction) and which by itself has little impact on the parties' rights and obligations and does not form part of the agreement to which the parties are bound.

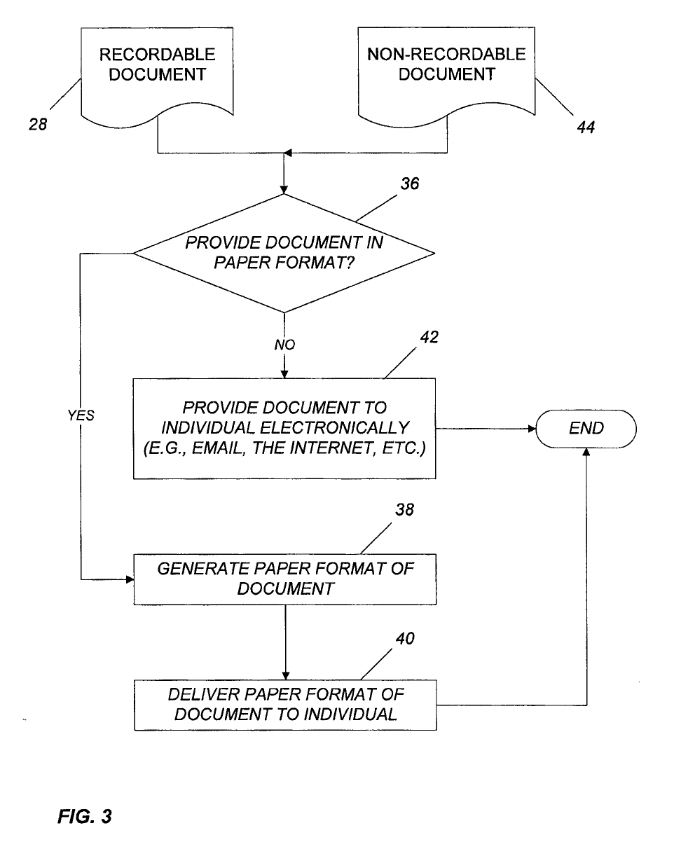

As shown in FIG. 1, after a recordable instrument 28 is generated, the recordable instrument 28 can be delivered to one or more applicants or entities associated with the transaction (step 34). FIG. 3 illustrates a method of delivering instruments, such as the recordable instrument 28, according to one embodiment of the invention. As shown in FIG. 3, the recordable instrument 28 can be delivered to an applicant in a paper format (step 36) by generating a hard-copy or paper form of the recordable instrument 28 (e.g., printing the recordable instrument 28) (step 38) and delivering the paper format of the recordable instrument 28 to the appropriate parties (step 40). The paper form of the recordable instrument 28 can include two one-sided pages of an oversized size (e.g., 13 inches long, 14 inches long, etc.) or can include two one-sided pages of a standard size (e.g., 8.5 inches by 11 inches). In some embodiments, the recordable instrument 28 also includes a third page (e.g., also in paper format) if certain conditions prevail in a particular transaction. For example, if the property associated with a transaction is a condominium or is part of a Planned Unit Development or if a loan provides for negative amortization, the recordable instrument 28 may include a third page. In some embodiments, the third (e.g., middle) page deals with options that are infrequent, and, therefore, the third page is discarded in most cases. For example, the third page can solve issues that need to be recorded if the legal description is too long to fit on the first page or can be used with transactions having a variable rate with the potential for negative amortization (where rates can change and payment streams do not keep pace), transactions involving a condominium or a planned unit development (where the lender needs to secure the common areas in addition to the particular parcel owned by the mortgagor), transactions having a variable rate with a limited right of assumption, transactions involving a non-principal residence, and/or transactions that include an escrow.

As shown in FIG. 3, in place of or in addition to delivering the recordable instrument 28 in a paper format, the recordable instrument 28 can be delivered to a party in an electronic format. If the recordable instrument 28 is delivered in an electronic format (step 36), the recordable instrument 28 can be delivered to the appropriate parties electronically (step 42). For example, the recordable instrument 28 can be transmitted to a party via at least one computer network (e.g., an email network, a local area network, the Internet, etc.) or can be delivered to a party via a computer-readable medium (e.g., a disk). In some embodiments, the recordable instrument 28 can be stored on a server that a party can access directly or indirectly (e.g., via one or more computer networks) in order to view and/or manipulate the recordable instrument 28. An electronic recordable instrument 28 can include (e.g., when printed or when viewed on a display) two one-sided pages of an oversized or a standard size (e.g., 8.5 inches by 11 inches).

In an electronic format, the recordable instrument 28 can include a “static” document and/or a “dynamic” document. A static document can include a copy of the paper format of the recordable instrument 28 in an electronic format (e.g., a generic word processor format, a Portable Document Format (“PDF”), etc.) that can be display and/or manipulated by a computing device (e.g., a personal computer). A dynamic document can include logic or functionality that formats the document based on input provided to the document, such as by eliminating unused or unneeded sections from an instrument before generating a final version of the instrument (e.g., generating a hardcopy instrument or electronically filing an electronic instrument). For example, if there is no negative amortization associated with a mortgage, logic included in a dynamic document can exclude the section of the recordable instrument 28 associated with negative amortization when a final version of the recordable instrument 28 is generated. Similarly, logic included in a dynamic document can eliminate blank space included in an instrument before generating a final version of the recordable instrument 28. For example, if a legal description of a transaction only takes up two lines of space of an available four lines of space, logic included in a dynamic document can eliminate the extra lines of space before generating a final version of a recordable instrument 28. In some embodiments, a recordable instrument 28 delivered in an electronic format and including a dynamic document is shorter than a similar recordable instrument 28 provided in paper format since logic included in the dynamic document can eliminate unused or unneeded text, space, etc. from the recordable instrument 28. For example, it is possible, based on the details of a particular transaction, that a recordable instrument 28 can include no more than 1 one-sided page of an oversized or a standard size by eliminating all information from a recordable instrument 28 not applicable to a particular transaction.

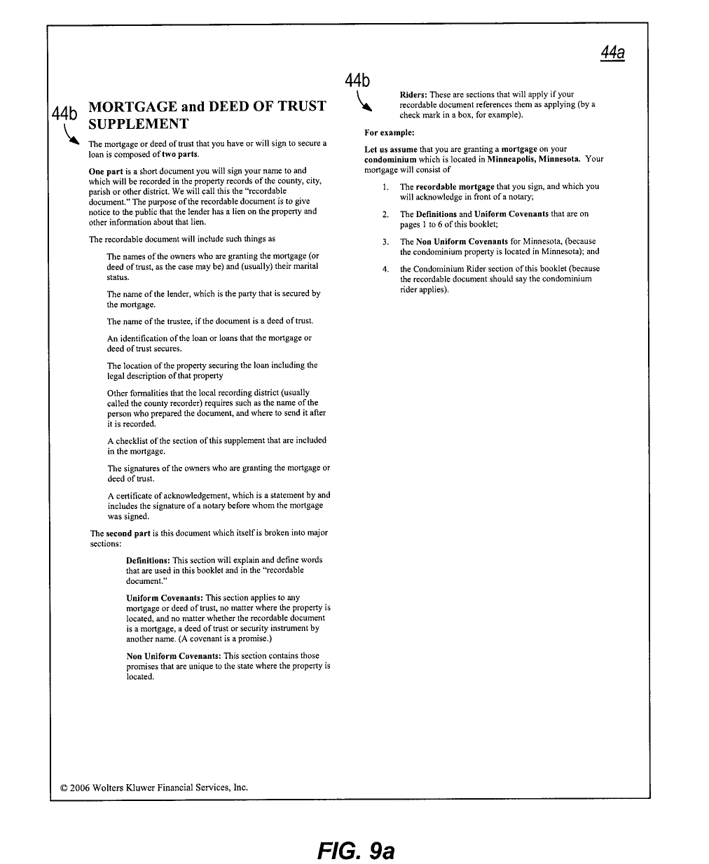

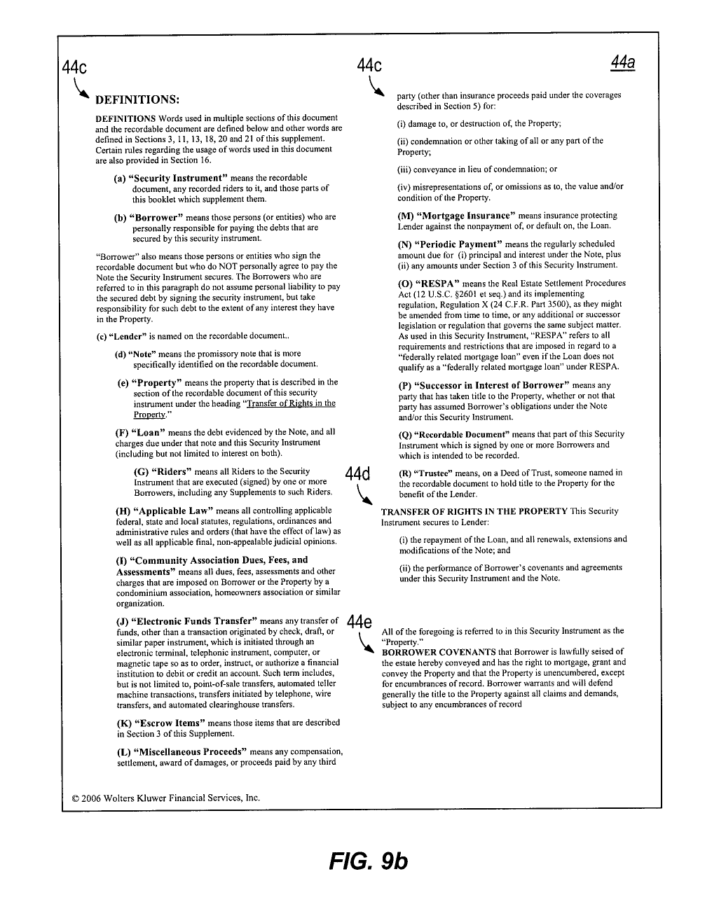

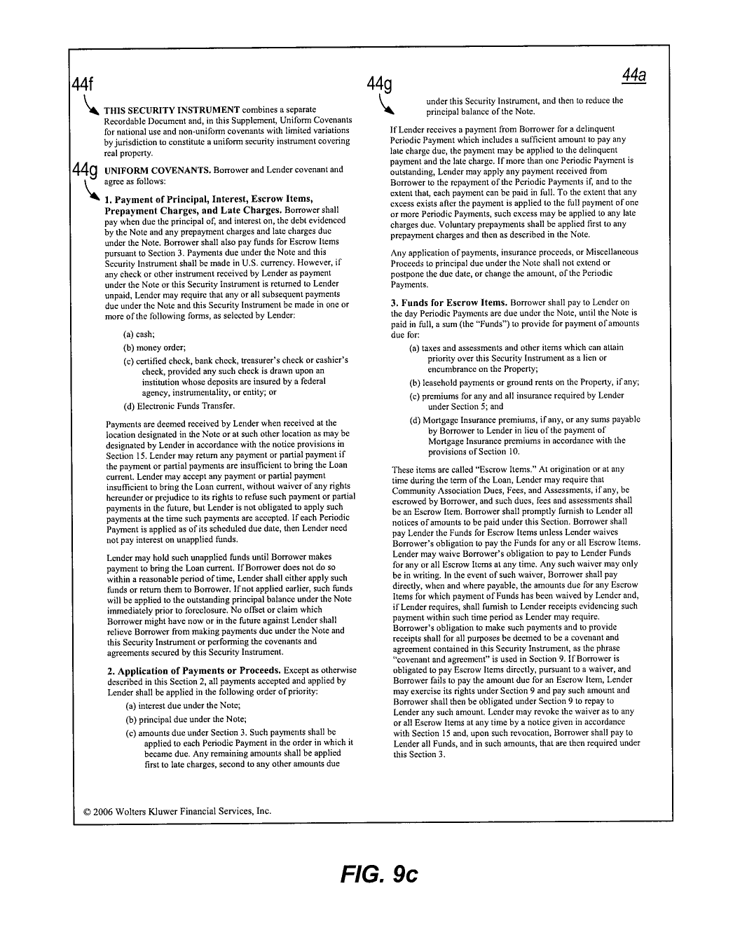

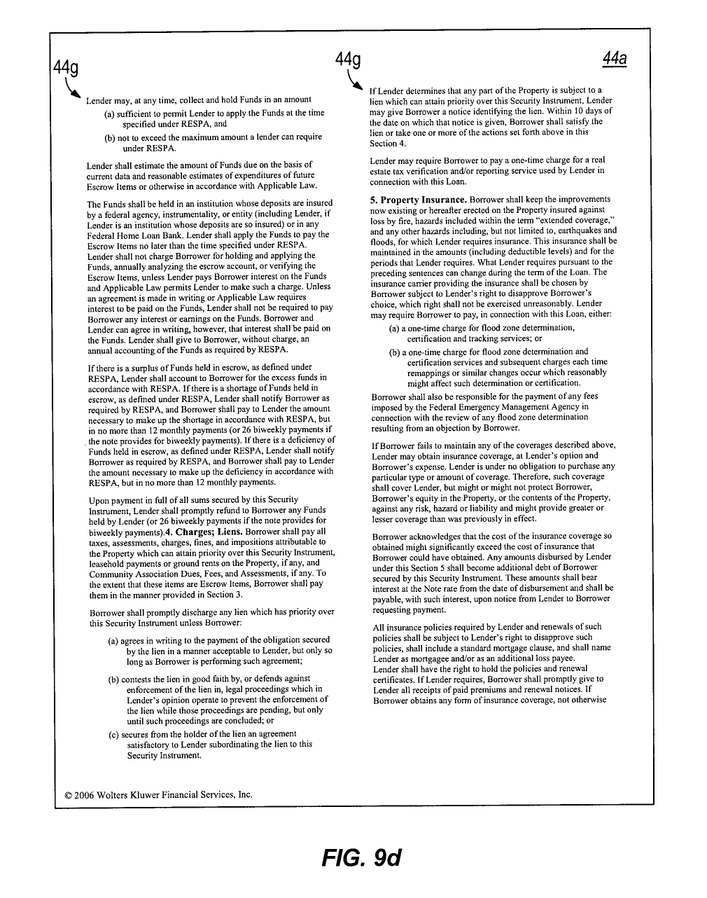

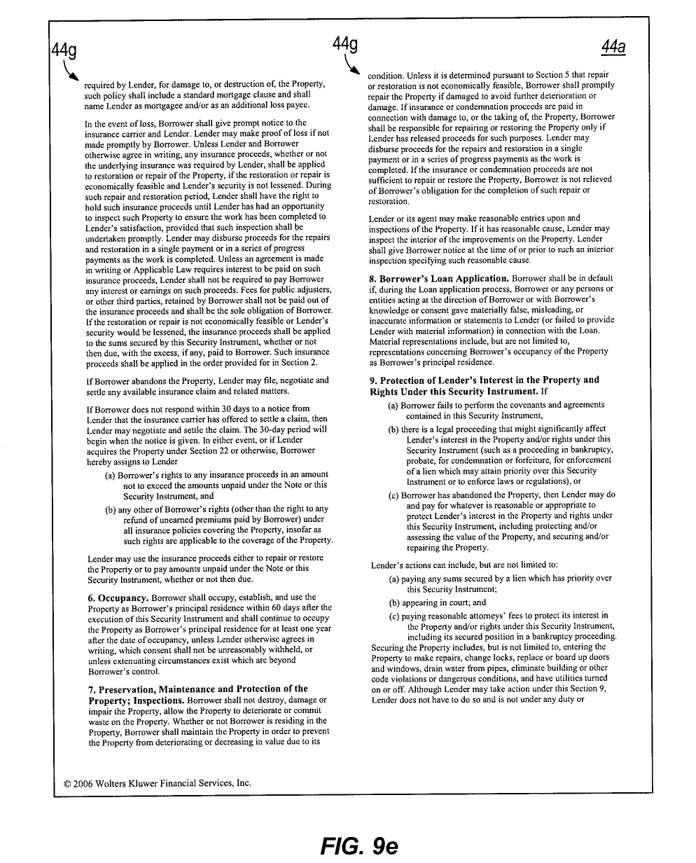

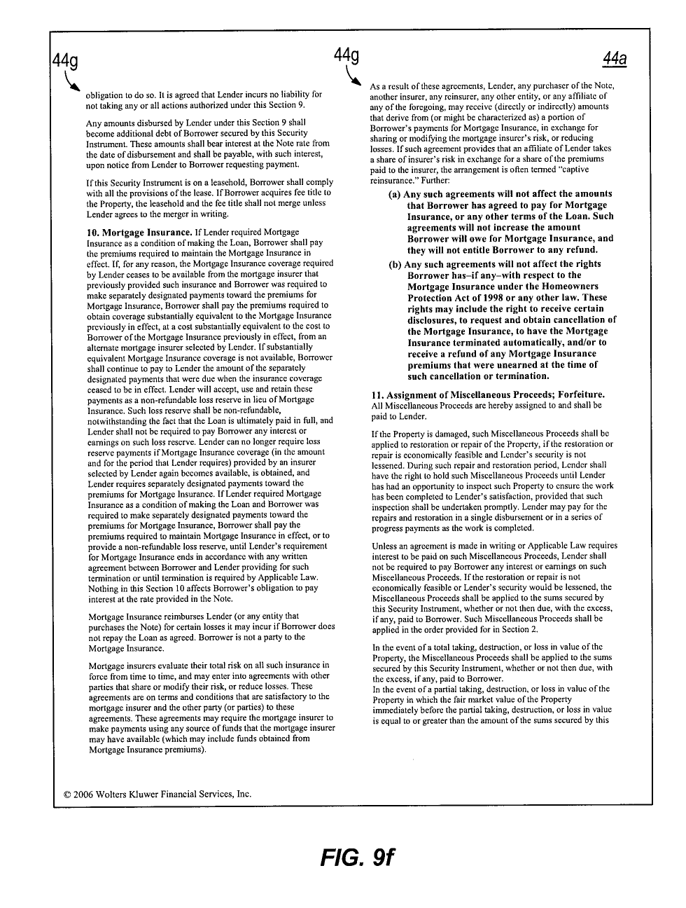

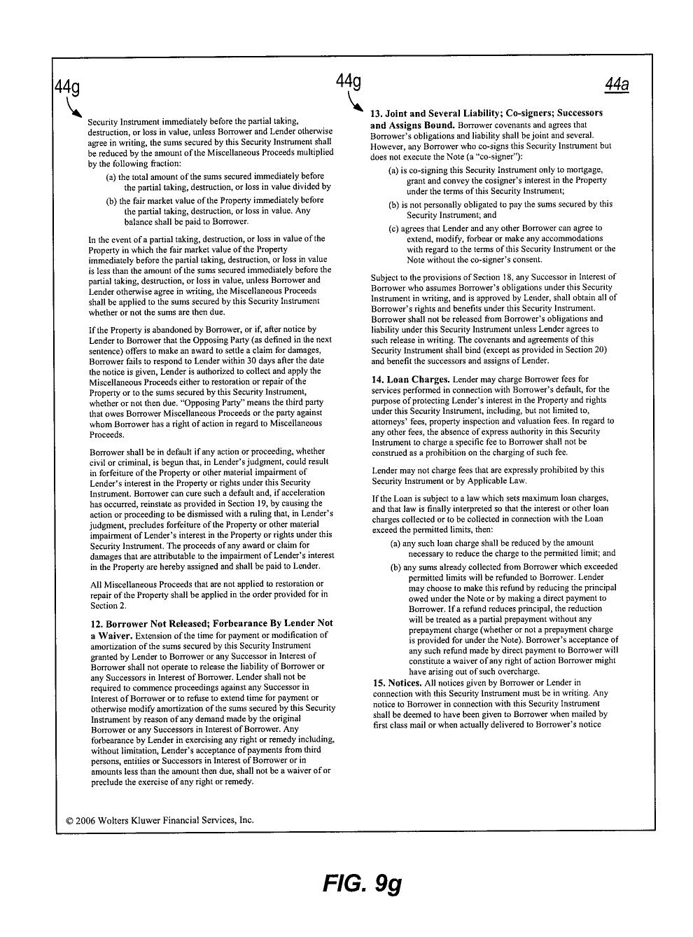

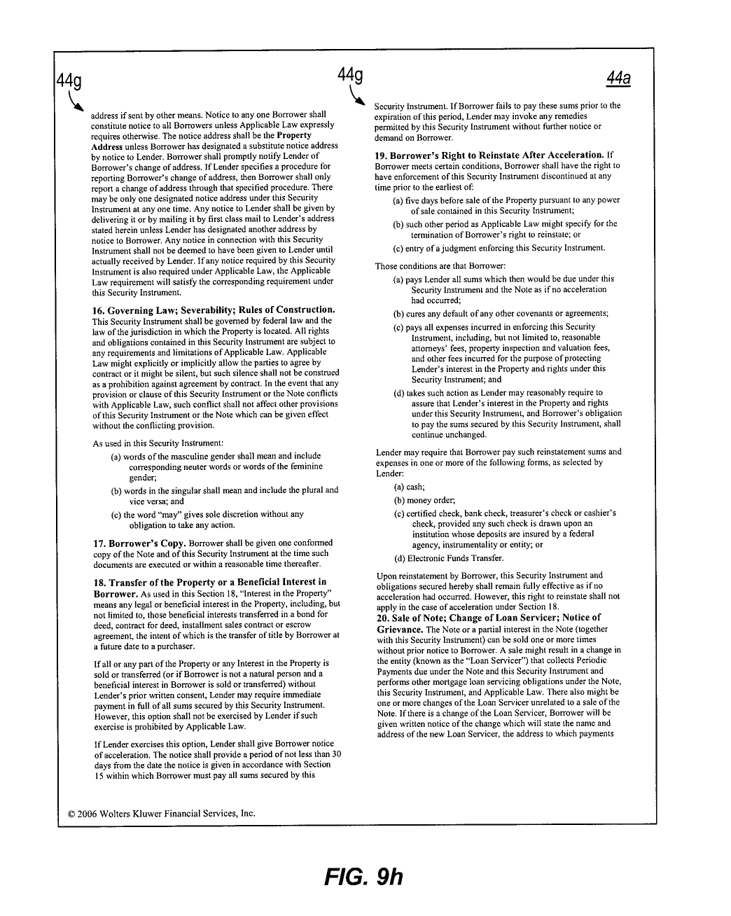

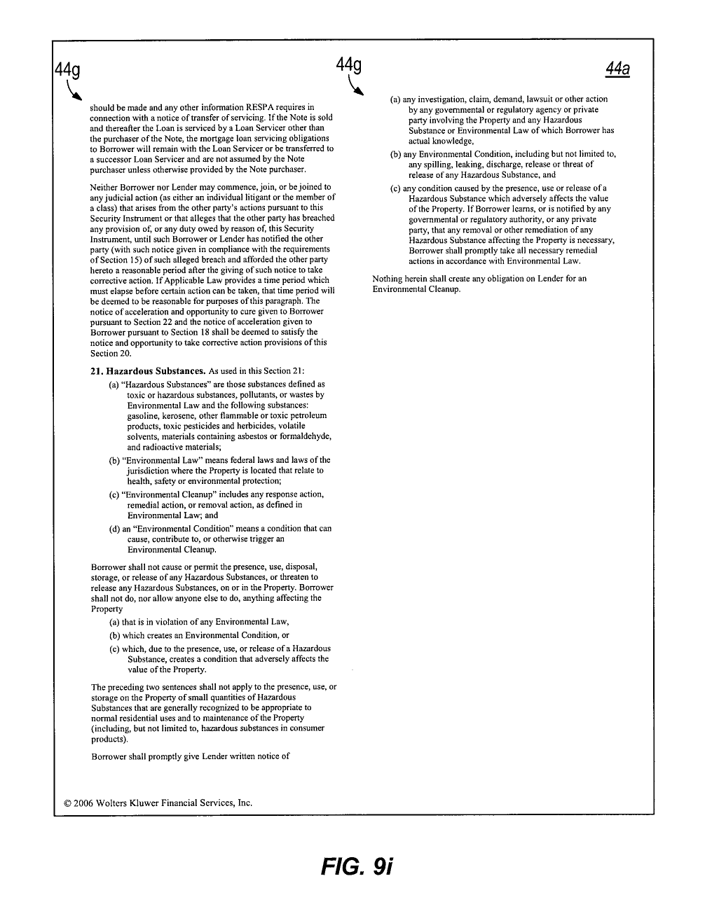

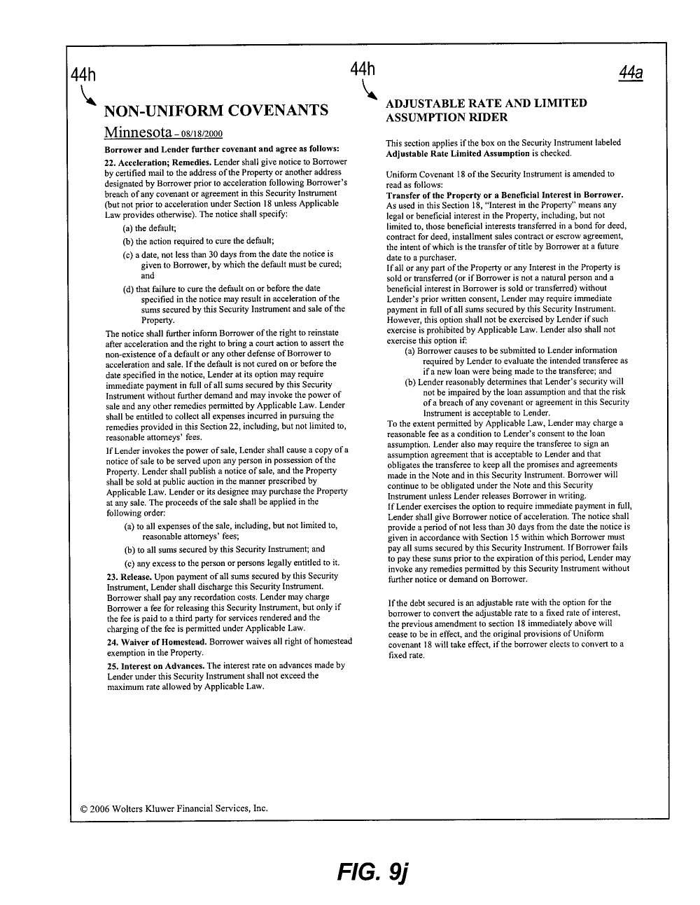

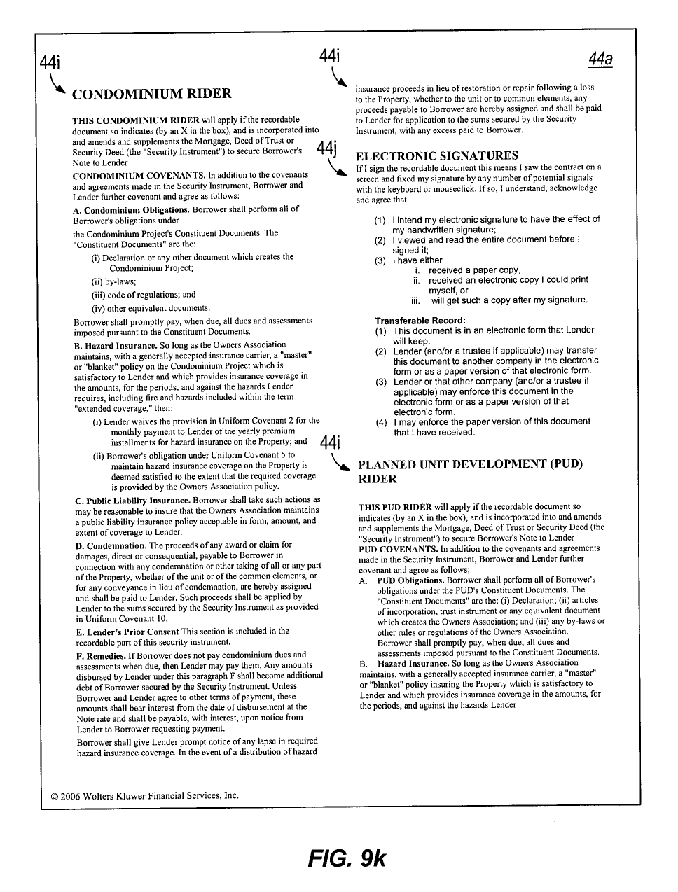

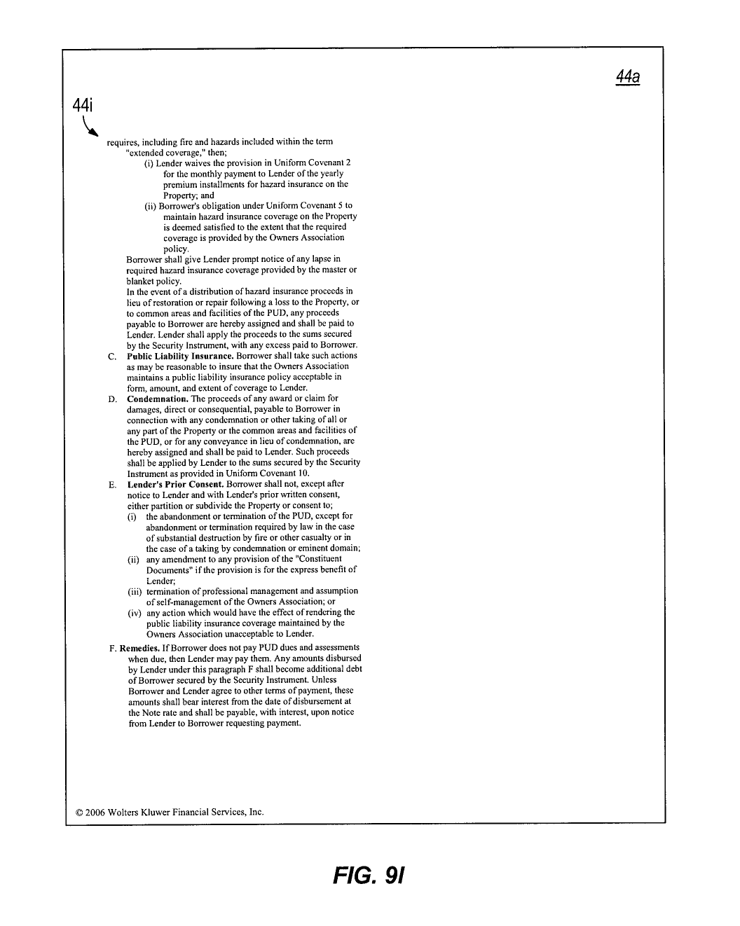

As shown in FIGS. 1 and 2, in addition to the recordable instrument 28, a non-recordable instrument 44 is also generated based on the identified non-recordable sections (steps 46 and 48, respectively). In some embodiments, the non-recordable instrument 44 includes a collection of the uniform covenants of the FNMA documents and the non-uniform covenants from the 50 states of the U.S. and the District of Columbia. As previously noted, a non-recordable instrument 44 can also be generated that only includes the uniform covenants and the non-uniform covenants for the state, county, or district where the property is located or that only includes the uniform covenants and the non-uniform covenants for all states, counties, districts, or locations that a particular lender or financial institution services. FIGS. 9A-9L illustrate a sample non-recordable instrument 44a according to an embodiment of the invention that is associated with a single jurisdiction (e.g., Minnesota).

As shown in FIGS. 9A-9L, the non-recordable instrument 44a includes an explanation section 44b, a definitions section 44c, a transfer of rights in the property section 44d, a borrower covenants section 44e, a this security instrument section 44f, a uniform covenants section 44g, a non-uniform covenants section 44h, a rider section 44i, and a signatures section 44j. The non-uniform covenants section 44h lists the non-uniform covenants of the jurisdiction associated with the non-recordable instrument 44a (e.g., Minnesota). A non-recordable instrument 44 that includes a collection of uniform covenants and non-uniform covenants from multiple jurisdictions or states could include a non-uniform covenants section that includes a specific district or state section for each jurisdiction or state (e.g., a specific district or state section 44j for each of the 50 states of the U.S. and the District of Columbia). In some embodiments, the non-recordable instrument 44 also includes a table of contents.

Similar to the signatures section 29s and the language 29u of the recordable instruments 28a and 28b, the explanation section 44b and the security instrument section 44f explains the purpose of the non-recordable instrument 44a and how it supplements what is recorded via the associated recordable instrument.

As shown in FIG. 1, after a non-recordable instrument 44 is generated, the non-recordable instrument 44 can be delivered to one or more parties (step 50). In some embodiments, a non-recordable instrument 44 can be delivered in similar ways that a recordable document 28 can be delivered. For example, as shown in FIG. 3, the non-recordable instrument 44 can be delivered in a paper format (step 40) or can be electronically delivered as a static document and/or a dynamic document (step 42).

As mentioned above, in some situations, riders or other additional forms or instruments associated with a transaction (e.g., a mortgage) are recorded with the transaction instrument, and, therefore, increase the number of pages recorded. Typical riders, however, do not need to be recorded or at least much of their usual content does not need to be recorded, and, therefore, can often be considered part of the non-recordable instrument 44. For example, variable rate riders associated with mortgages simply recite what is in the note itself, and the FNMA/FHLMC have eliminated the interest rate and the periodic payment amount in their fixed rate recordables in recognition of the fact that this information is not necessary for perfection of the transaction and would violate a customer's right of privacy if published. In addition, if sections of a rider are recordable, the recordable sections can be placed in the recordable instrument 28 and the remaining sections of the rider can be associated with the non-recordable instrument 44. For example, the recordable instrument 28 can give notice if an undefaulted variable rate transaction could still produce negative amortization or can include the recordable parts of the Planned Use Development and the Condo riders in order to gain security in the common areas. The balance of these riders, however, does not need to be recorded and can be associated with the non-recordable instrument 44 for the transaction.

It should be understood that, in some embodiments, similar recordable instruments 28 and non-recordable instruments 44 can be used for multiple types of transactions. For example, similar instruments 28 and 44 can be used for open ended, closed, and reverse mortgages without requiring different, specific instruments. Typically, some of the primary differences between current recordables for different types of mortgages are in the elements of default. For example, open end home equity mortgages have limitations on permissible elements, but these limitations are already in the debt instruments and they do not need to be in the mortgage instruments. Therefore, if you eliminate these elements from the mortgages you eliminate the need to carry the different products. The same can be true in the reverse mortgage products. For example, the only elements of default needed in the mortgage instrument for a reverse mortgage is a reference to those elements of default in the note or credit agreement associated with the mortgage.

In addition, by segregating mortgage content into a recordable instrument 28 and a non-recordable document 44, a lender or a financial institution can deliver the non-recordable instruments 44 associated with a mortgage using low-cost methods and can deliver the non-recordable instruments 44 associated with a mortgage earlier in the mortgage process. For example, non-recordable instruments 44 can be delivered to parties associated with a mortgage before closing the mortgage and can be delivered electronically. By providing the non-recordable instruments 44 earlier in the mortgage process, some of the initializations that slow down a closing can be reduced. In addition, the earlier and easier that a party can receive the non-recordable instruments 44, the more time the party has to read and review the content of the non-recordable instruments 44, which, regardless of whether a party actually reads a non-recordable instrument 44, can make the non-recordable instrument 44 more legally enforceable as compared to current mortgage documents.

As shown in FIG. 1, after generating a recordable instrument 28 and a non-recordable instrument 44 and delivering the instruments 28 and 44 to the appropriate parties, one or both of the instruments 28 and 44 can be executed by the appropriate parties (steps 52 and 54). In some embodiments, one or both of the instruments 28 and 44 can be electronically signed or executed. For example, if one or both of the instruments 28 and 44 were provided in an electronic format, the instruments can include logic that allows a party to electrically fill in and/or electronically sign the instrument(s) 28 and 44. A software application used by a party to view and/or manipulate the instrument(s) 28 and 44 in an electronic format can also be used to electronically fill in and/or electronically sign the instrument(s) 28 and 44.

After a recordable instrument 28 is executed (step 52), the recordable instrument 28 is recorded (step 56). In some embodiments, a recordable instrument 28 can be recorded electronically. For example, the fields and/or format of a recordable instrument 28 can be standardized. In addition, a recordable instrument 28 can include space for issues related to the Mortgage Electronic Registration System. To electronically file a recordable instrument 28, the executed recordable instrument 28, or a version thereof, can be transmitted over at least one computer network to a computing device operated by a registrar.

As noted above, due to the shortened nature of the recordable instrument 28, the handling, delivery, and filing fees associated with the recordable instrument 28 are reduced. In addition, typical recordable mortgage instruments often contain recitations of what the law currently is. If and when that law changes, the recordable instruments need to be changed. Furthermore, the page size and margin regulations of recordable instruments can also change and cause the recitations to change. By removing non-recordable citations from a recordable instrument, the recordable instrument 28 does not need to be changed.

As noted above, embodiments of the invention can provide advantages over the prior art. For example, per-page recording savings is an obvious advantage, and, in the short term, can be the biggest motivation for using embodiments of the invention. Even lenders who pass recording costs to borrower can benefit from using embodiments of the invention. For example, lenders that pass recordings costs to borrowers but minimize the passed costs (e.g., by generating shorter recordable instruments) can have an advantage over lenders who do not minimize the borrower's recording costs. In addition, a lender who minimizes the borrower's recording costs can lower the borrower's total closing costs and/or can charge the borrower an identical or smaller fee and keep at least a portion of the fee that is saved due to the shortened recordable instrument.

In some embodiments, the types of instruments (e.g., paper format, electronic format, dynamic format, static format, etc.) that provide the greatest advantage to a particular lender depend on the volume of mortgages the lender originates and the number of jurisdictions that the lender operates in. For example, a lender that originates a large volume of mortgages in a large number of jurisdictions may choose to use a dynamic recordable instrument and a dynamic non-recordable instrument. While there is a cost associated with creating the software to make dynamic instruments, the cost of the software could be recouped faster given that recordable instruments generated by the software would be as short as possible (e.g., 2 pages) and, therefore, would be associated with smaller recording fees. In addition, if a lender uses dynamic non-recordable instruments, the lender can print or electronically deliver the non-recordable instruments and can make as short as possible for a particular transaction. Furthermore, the programming required for generating dynamic non-recordable instruments is typically simple (e.g., only based on the jurisdiction where the real estate associated with a mortgage is located) and, therefore, may not be associated with large creation and/or maintenance costs.

In contrast, if a lender only conducts business in a single jurisdiction (e.g. a lender who only originates mortgages in one state), the lender may not require a dynamic non-recordable document (i.e., since each non-recordable instrument would be the same for each transaction), and, as such, a lender could use a static, electronic non-recordable instrument for applicants and borrowers who agree to accept electronic delivery of the instrument and could either preprint a supply of non-recordable instruments (e.g., with a useful life of about a year) or print a non-recordable instrument using a printer on an as needed basis for applicants and borrowers who request a paper version of the non-recordable instrument. In some embodiments, a lender can decide whether to preprint non-recordable instruments or print non-recordable instruments on an as needed basis based on the cost of obtaining and maintaining printers for printing non-recordable documents as needed, the risk of commercially printed instruments becoming obsolete, and the legislative year for the jurisdiction.

Similarly, a lender that only conducts business in a single jurisdiction can choose a specific form of a recordable instrument based on the state, the lender's market, the lender's volume, and the printing vs. software creation expenses. In some embodiments, the most likely instrument choice for a lender originating a small volume of transactions within a single jurisdiction would be paper or static, electronic recordable instruments. For example, a few states do not charge on a per-page basis and a few states only charge $1 or $2 a page. In such states and for lenders operating in such states, there is not the same incentive to pay for software creation and maintenance that can create the shortest possible recordable instruments. In addition, if a lender is located in a jurisdiction where condominiums or Planned Unit Developments are uncommon, the middle page of the recordable form is more likely to be eliminated for each transaction and, therefore, software that automatically eliminates the third page would be unnecessary. Likewise, a regional lender (e.g., a lender whose mortgage market spans several jurisdictions) can consider the same cost benefit analysis when deciding the types of forms to use. For example, a lender may favor a dynamic non-recordable instrument and a dynamic recordable instrument the greater the volume of mortgages that the lender originates, the higher the per-page fees of the jurisdictions that the lender operates in, and the more jurisdictions that the lender serves.

After the recordable instrument 28 has been executed, one or both of the instruments 28 and 44 can be archived for future access. Given the segregation of the mortgage content, the bulk of the mortgage content can be eliminated, which can make archives of mortgages easier to create and maintain. For example, the boilerplate parts of a mortgage instrument can be stored once by revision date or usage date.

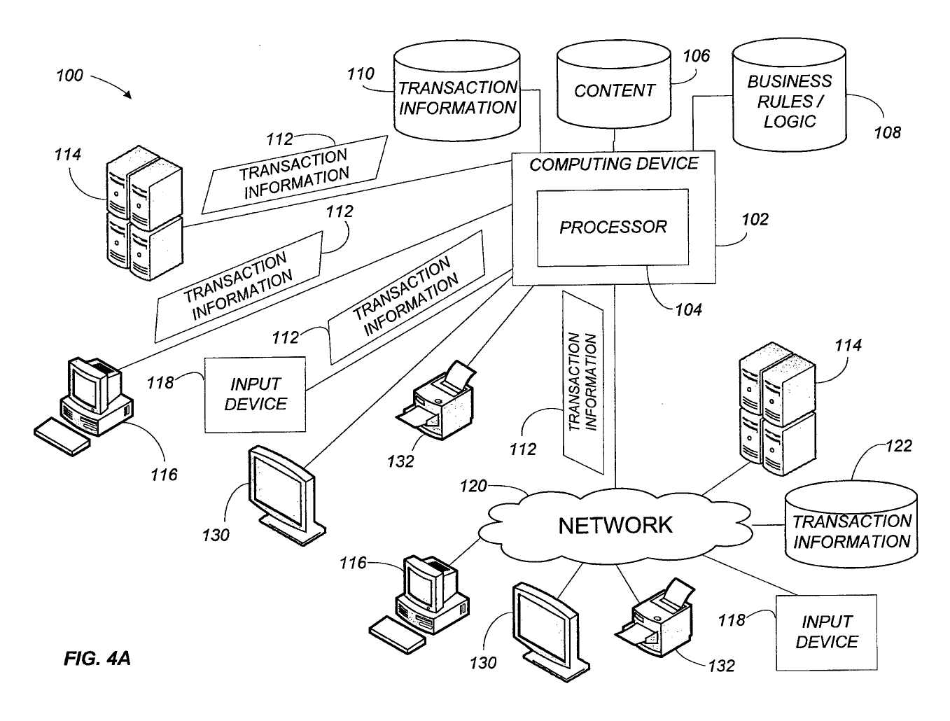

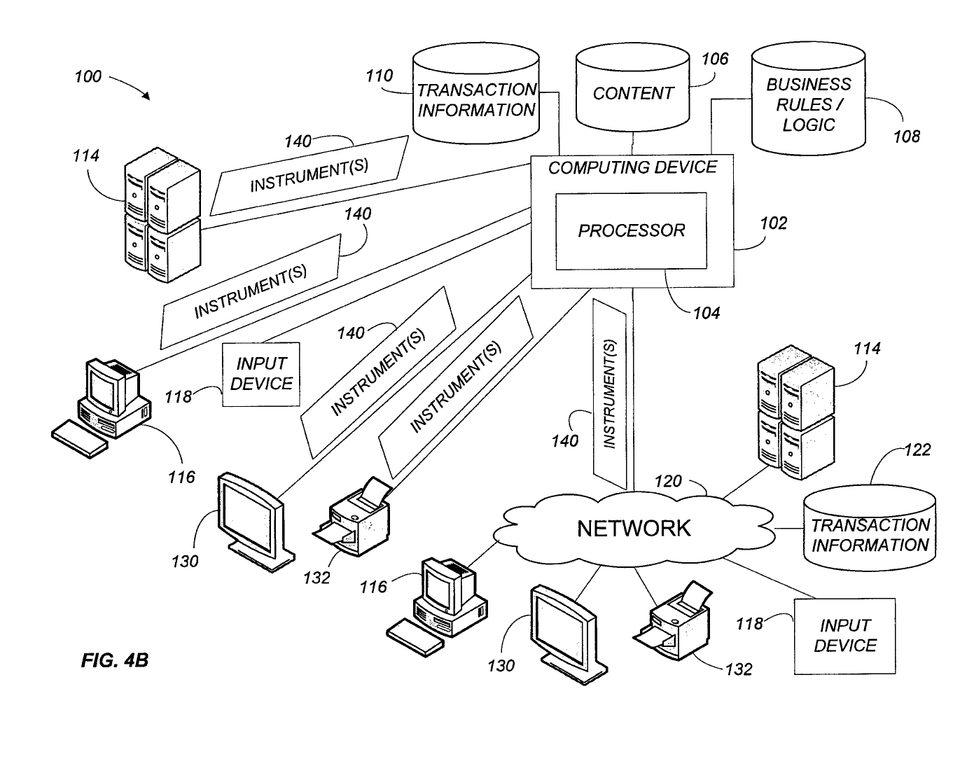

It should be understood that embodiments of the invention can be automatically performed using one or more processors, computer networks, etc. For example, in some embodiments, a processor can be configured to generate a non-recordable instrument and a recordable instrument for a mortgage process or another type of transaction. FIGS. 4A and 4B illustrate a system 100 for documenting and perfecting a transaction according to one embodiment of the invention. As shown in FIG. 4A, the system 100 includes a computing device 102 that includes at least one processor 104. The computing device 102 can take the form of a server, a personal computer, etc.

To generate recordable and non-recordable instruments, the processor 104 can access one or more data storage mechanisms (e.g., drives, disks, databases, or other forms of computer-readable medium), such as a content storage mechanism 106 and/or a business rules/logic storage mechanism 108. The content storage mechanism 106 can store standard, available, or possible content for one or more types of transactions. For example, when used to create recordable and non-recordable mortgage instruments, the content storage mechanism 106 can include content from a typical mortgage instrument, such as a FNMA/FHLMC document.

In some embodiments, content stored in the content storage mechanism 106, can include metadata that identifies and/or classifies particular sections of content. For example, content stored in the content storage mechanism 106 can be written or structured according to a markup language, such as the extensible markup language, that identifies the text or language included in the content and the format or structure of the text. The order and structure of the content as it is stored in the content storage mechanism 106 can also provide metadata that provides additional information about the content.

The business rules/logic storage mechanism 108 can store logic (e.g., rules, lookup tables, etc.) defining how to select and organize content stored in the content storage mechanism 106 in order to generate a recordable instrument and/or a non-recordable instrument. In some embodiments, the business rules/logic storage mechanism 108 stores guidelines or rules that govern what information is applicable to a particular transaction and/or what information is to be included in a recordable and/or a non-recordable instrument. For example, the business rules/logic storage mechanism 108 can store logic that defines what information is required and/or typically included in an instrument for a particular transaction in a particular state, district, or location with particular transaction details.

The business rules/logic storage mechanism 108 can also store logic that defines format requirements for recordable instruments. For example, many states have format issues that need to be considered when assembling recordable instruments. The format issues can include requirements for specific titles (e.g., a title that describes the type of transaction the document embraces), pages sizes (e.g., paper 8.5 inches by 11 inches in size), type sizes, margins for page content (e.g., required clear space for adding recording and retrieval information the recorded document), paper weight, document information (e.g., drafter information and return information), signer information (e.g., printed signer's name below signature), and authentication memorials (e.g., witnesses, certificates of acknowledgement by a notary, etc.).

The processor 104 can be configured to access the content storage mechanism 106 and/or the business rules/logic storage mechanism 108 in order to generate a recordable instrument and/or a non-recordable instrument. It should be understood that the functionality of and data stored in the content storage mechanism 106 and the business rules/logic storage mechanism 108 can be combined within a single data storage mechanism or can be distributed among additional data storage mechanisms. For example, the processor 104 may access a previously-generated and stored instrument from an internal or external data storage mechanism and can use the previously-generated instrument to generate a recordable and/or a non-recordable instrument. The previously-generated instrument can include a static document or a dynamic document, as described above.

In some embodiments, the processor 104 can be configured to generate a generic recordable instrument and/or a generic non-recordable instrument that includes all standard, available, or possible content. Since the generic instruments include all possibly applicable content, the generic instruments can be used by multiple parties for various types of a transaction (e.g., various types of mortgages).

In other embodiments, the processor 104 can be configured to generate a recordable instrument and/or a non-recordable instrument that is customized for a particular lender or financial institution or customized for a particular transaction. For example, as shown in FIG. 4A, the processor 104 can optionally access transaction information that specifies the details of a particular lender or financial institution and/or details of a particular transaction. In some embodiments, the processor 104 can obtain transaction information from a transaction information storage mechanism 110. The transaction information storage mechanism 110 can store information about one or more lenders or financial institutions and/or can store information about one or more transactions.

It should be understood that although FIG. 4A illustrates the data storage mechanisms 106, 108, and 110 as being external to the computing device 102, one or more of the storage mechanisms 106, 108, and 110 can be internal to the computing device 102 and/or the processor 104. As noted above, the functionality and data stored by the data storage mechanisms 106, 108, and 110 can be combined or distributed in various configurations.

In some embodiments, in addition to or in place of obtaining transaction information from the transaction information storage mechanism 110, the processor 104 can receive transaction information 112 from an input source, such as an external server 114, an external computing device 116 (e.g., a personal computer), an external input device 118 (e.g., a keyboard, a mouse, a joystick, a trackball, a touch screen, a scanner, a camera, etc.), etc. As shown in FIG. 4A, the processor 104 can obtain transaction information 112 from an external server 114, an external computing device 116, and/or an external input device 118 that is directly connected to the processor 104, or the processor 104 can obtain transaction information 112 indirectly, such as through one or more networks 120. The network(s) 120 can include a local area network, a wide area network, the Internet, etc. The processor 104 can also obtain transaction information 112 from an external transaction information storage mechanism 122 indirectly connected to the processor 104 via the network 120. For example, the external transaction information storage mechanism 122 can include a database managed by a particular lender that stores information about transactions managed by the lender, and the lender can transmit the transaction information to the processor 104 over the network 120 in order to have the processor 104 generate associated instruments for the transactions. It should be understood that the processor 104 can be managed by a lender or a financial institution or can be managed by a third-party.

The processor 104 can use the transaction information 112, the logic stored in the business rules/logic storage mechanism 108, the content stored in the content storage mechanism 106, and/or a previously-generated instrument to determine specific content that is applicable to a particular transaction. For example, logic stored in the business rules/logic storage mechanism 108 can specify that if the transaction information 112 indicates that a particular transaction involves property located in a specific state, district, or location, the processor 104 should generate an instrument that includes specific content (e.g., specific language, provisions, etc.) that relates to the state, district, or location where the property is located and, in some embodiments, should exclude the language, provisions, etc. that does not relate to the state, district, or location wherein the property is located. As noted above, logic stored in the business rules/logic storage mechanism 108 can also specify that the processor 104 should generate a generic instrument that includes all standard, available, or possible content.

As also described above, content stored in the content storage mechanism 106 can include metadata that can also be processed by the processor 104 when generating an instrument. For example, metadata associated with the content can specify whether particular content sections or language applies to particular states, districts, locations, etc.

After the processor 104 determines applicable content for one or more instruments (e.g., via the transaction information 112, the content stored in the content storage mechanism 106, and/or the logic stored in the business rules/logic storage mechanism 108), the processor 104 can determine recordable and non-recordable content included in the applicable content. In some embodiments, the processor 104 uses the transaction information 112, the content stored in the content storage mechanism 106, and/or the logic stored in the business rules/logic storage mechanism 108 to determine recordable content and non-recordable content. For example, similar to the process performed by the processor 104 to determine applicable content for a particular transaction, the processor 104 can access the transaction information 112 and/or the logic stored in the business rules/logic storage mechanism 108 to determine what information or content is required to be recorded based on the details of a particular transaction and/or the current recording guidelines or regulations. The processor 104 can also use metadata included in the applicable content to determine particular content that is required to be recorded. For example, the metadata can include flags that identify recordable and/or non-recordable content or can include content identifiers that can be matched to recordable or non-recordable content based on current recording guidelines or regulations (e.g., specified by the logic stored in the business rules/logic storage mechanism 108).

As shown in FIG. 4B, after the processor 104 determines recordable content and non-recordable content, the processor 104 can generate and output one or more instruments 140 (e.g., a first mortgage instrument containing recordable content and a second mortgage instrument containing non-recordable content which together form a single binding agreement). In some embodiments, the processor 104 can also fill in information in one or more of the instruments 140. For example, the processor 104 can fill in information in the instruments 140 based on the transaction information 112. After generating the instruments 140, the processor 104 may present the instruments 140 to a user for manual review. For example, the processor 104 may transmit the instruments 140 to external computing device 116 and or a display device 130 directly or indirectly connected to the processor 104 for manual review. The processor 104 can also obtain instructions from a user regarding modifications to be made to the instrument 140 via an external computing device 116 and/or input source 118. The processor 104 can apply the instructed modifications to the instruments 140 before generating a final version of the instruments 140 for distribution.

As described above, the instruments 140 can include a hard-copy instrument and/or an electronic instrument. For example, in some embodiments, the processor 140 can be configured to generate a paper format version of the generated instruments 140 (i.e., via a printing device 132 directly or indirectly coupled to the processor 104). In other embodiments, the processor 104 can be configured to display the generated instrument 140 via a display device 130 directly or indirectly connected to the processor 104. In still other embodiments, the generated instruments 140 can be transmitted to an external server 114 and/or an external computing device 116 directly connected to the processor 104 or indirectly connected to the processor 104 over the network(s) 120. The processor 104 can also store the instruments 140 to an internal or external data storage mechanism directly connected to the processor 104, such as the transaction information storage mechanism 110, or can store the instruments 140 to an external data storage mechanism, such as the external transaction information storage mechanism 122, that is indirectly connected to the processor 104 via the network(s) 120.

It should be understood by one of ordinary skill in the art that embodiments of the invention described above are exemplary illustrations. Other configurations and designs are possible. Various features and advantages of the invention are set forth in the following claims.

What is claimed is:

1. A computer implemented method of creating a multiple-part mortgage document, the method comprising:
accessing a store of mortgage document content;
selecting portions of the mortgage document content to be included in the multiple-part mortgage document according to business rules stored in a computer accessible memory and user specified transaction data;
determining a recordable portion of the selected content by accessing the computer accessible memory and applying one or more of the business rules,
wherein the recordable portion of the selected content includes legal provisions that affect the rights, obligations, or both of the parties to the mortgage transaction;
creating a recordable legal instrument including the recordable portion of the selected content, the recordable legal instrument configured to be recorded in a public registry of legal records;
determining a non-recordable portion of the selected content by accessing the computer accessible memory and applying one or more of the business rules such that the non-recordable portion includes a plurality of contract provisions; and
creating a non-recordable legal instrument including the non-recordable portion of the selected content.

2. The computer implemented method of claim 1 further comprising placing a reference in the recordable legal instrument, the non-recordable legal instrument, or both indicating that the recordable legal instrument and the non-recordable legal instrument are intended, together, to form a binding contract.

3. The computer implemented method of claim 1 further comprising perfecting a security interest by recording the recordable legal instrument in a public registry of legal records.

4. The computer implemented method of claim 1 wherein the store of mortgage document content includes uniform covenants applicable to all jurisdictions and non-uniform covenants applicable to specific jurisdictions.

5. The computer implemented method of claim 1 wherein the act of selecting content includes:
determining a jurisdiction; and
selecting content applicable to the jurisdiction.

6. The computer implemented method of claim 1 wherein the act of selecting content includes:
determining a type of mortgage; and
selecting content applicable to the type of mortgage.

7. The computer implemented method of claim 1 wherein the recordable legal instrument is a dynamic electronic document including embedded logic that dictates content included in the recordable legal instrument.

8. The computer implemented method of claim 1 wherein the recordable legal instrument is a static electronic document.

9. A computer implemented method of creating a multiple-part mortgage document, the method comprising:
determining a recordable portion of content applicable to the multiple-part mortgage document and a non-recordable portion of content applicable to the multiple-part mortgage document by executing on a computer a first set of computer readable instructions configured to
analyze data associated with an item from a plurality of content items stored on a computer accessible memory,
determine whether the item is to be included in the recordable portion based on the data, and
determine whether the item is to be included in the non-recordable portion based on the data; and
generating a recordable legal instrument and a non-recordable legal instrument by executing a second set of computer readable instructions
wherein the recordable legal instrument includes the recordable portion and the non-recordable legal instrument includes the non-recordable portion.

10. The computer implemented method of claim 9 wherein the data associated with the item from the plurality of content items is in the form of metadata indicating when the item is included in the recordable portion and when the item is included in the non-recordable portion.

11. The computer implemented method of claim 9 further comprising:
storing the data associated with the item on a computer accessible memory as at least one look-up table; and
configuring the look-up table to include an indication of when the item is included in the recordable portion and when the item is included in the non-recordable portion.

12. The computer implemented method of claim 9 further comprising:
placing a reference in the recordable legal instrument indicating that the recordable legal instrument and the non-recordable legal instrument are intended, together, to form a binding contract.

13. The computer implemented method of claim 9 further comprising:
placing a reference in the non-recordable legal instrument indicating that the recordable legal instrument and the non-recordable legal instrument are intended, together, to form a binding contract.

14. The computer implemented method of claim 9 wherein the recordable legal instrument is a dynamic electronic document including embedded logic that dictates content included in the recordable legal instrument.

15. The computer implemented method of claim 9 wherein the recordable legal instrument is a static electronic document.

16. A multiple-part contract document creation system comprising:
at least one computer accessible memory;
a plurality of content items stored on the at least one computer accessible memory;
data associated with one or more of the plurality of content items stored on the at least one computer accessible memory; and
a processor configured to
analyze the data associated with one or more of the plurality of content items,
determine whether content items are to be included in a recordable portion of content applicable to the multiple-part contract document,
determine whether content items are to be included in a non-recordable portion of content applicable to the multiple-part contract document,
generate a recordable legal instrument including the recordable portion, and
generate a non-recordable legal instrument including the non-recordable portion.

17. The system of claim 16 wherein the data associated with one or more content items is in the form of metadata indicating when each content item is included in the recordable portion and when each content item is included in the non-recordable portion.

18. The system of claim 16
wherein the data is stored on the computer accessible memory as at least one look-up table, and
wherein the look-up table includes an indication when each content item is included in the recordable portion and when each item is included in the non-recordable portion.

19. The system of claim 16:
wherein the recordable legal instrument includes a reference indicating that the recordable legal instrument and the non-recordable legal instrument are intended, together, to form a binding contract.

20. The system of claim 16:
wherein the non-recordable legal instrument includes a reference indicating that the recordable legal instrument and the non-recordable legal instrument are intended, together, to form a binding contract.

21. The system of claim 16 wherein the recordable legal instrument is a dynamic electronic document including embedded logic that dictates content included in the recordable legal instrument.

22. The system of claim 16 wherein the recordable legal instrument is a static electronic document.

23. A method of creating a multiple-part mortgage document, the method comprising:
determining content applicable to a mortgage transaction according to the nature of the mortgage transaction and applicable laws;
determining a first set of content from the applicable content, wherein the first set of content is required to be recorded in order to perfect the security interest;
determining a second set of content from the applicable content, wherein the second set of content is not required to be recorded in order to perfect the security interest;
generating a recordable legal instrument containing the first set of content; and
generating a non-recordable legal instrument containing the second set of content.
